(19) United States
(12) Patent Application Publication
(10) Pub. No.: US 2014/0060073 A1
(43) Pub. Date: Mar. 6, 2014

(54) MULTIPLE POINT OVERBOARD EXTRACTOR FOR GAS TURBINE

(71) Applicants: Ilya Aleksandrovich SLOBODYANSKIY, Greenville, SC (US); Gilbert Kraemer, Greenville, SC (US); David Williamson, Greenville, SC (US); Leonid Ginessin, Moscow (RU); Edward Cummings, Greenville, SC (US)

(72) Inventors: Ilya Aleksandrovich SLOBODYANSKIY, Greenville, SC (US); Gilbert Kraemer, Greenville, SC (US); David Williamson, Greenville, SC (US); Leonid Ginessin, Moscow (RU); Edward Cummings, Greenville, SC (US)

(73) Assignee: General Electric Company, Schenectady, NY (US)

(21) Appl. No.: 13/596,684

(22) Filed: Aug. 28, 2012

(51) Int. Cl. F02C 6/08

(52) U.S. Cl. 60/782; 60/785

(57) ABSTRACT

The disclosed overboard extractor provides overboard extraction of compressor fluid at multiple extraction points. The overboard extractor includes multiple extraction manifolds and a delivery manifold for extracting the compressor fluid from the multiple extraction points. The overboard extractor also includes extraction valves and a delivery valve to control the extraction flow through each extraction manifold. The overboard extractor can operate in a delivery mode, a closed loop mode, or a mixed mode.

One or more aspects of the present invention relate to multiple point overboard extractor for a gas turbine. In particular, one or more aspects of the present invention relate to overboard extraction of compressed fluid through the multiple extraction points.

### BACKGROUND OF THE INVENTION

In a typical gas turbine system, air is compressed by a compressor and the compressed air is mixed with fuel for combustion. A gas turbine system can also include features to extract a portion of the compressed air fluid, e.g., compressed air, from the compressor to be diverted for purposes other than combustion. As an example, the diverted compressed air can be used to cool parts of the combustor hardware. In an airplane, the diverted compressed air can be used to pressurize the cabin.

However, if the overboard extraction is not carefully controlled, it can have detrimental effects. For example, the combustor hardware may not be adequately cooled. Thus, it is desirable to manage the overboard extraction so that the benefits provided by the overboard extraction are maintained while at the same time, providing sufficient cooling to the combustor hardware.

### BRIEF SUMMARY OF THE INVENTION

A non-limiting aspect of the present invention relates to an overboard extractor for overboard extraction of compressed fluid from a compressor in a gas turbine system. The overboard extractor comprises a delivery manifold, a delivery valve, a plurality extraction manifolds arranged such that first ends thereof are fluidly connected to a compressed fluid path and second ends thereof are fluidly connected to the delivery manifold, and a plurality of extraction valves corresponding to the plurality of extraction manifolds. The compressed fluid path is a fluid path arranged to provide the compressed fluid from an exit of the compressor to a combustor head end. The plurality of extraction valves are arranged such that the compressed fluid flowing between the compressed fluid path and the delivery manifold through each extraction manifold is individually controllable. The delivery valve is arranged to be located downstream of all of the plurality of extraction manifolds along the delivery manifold. The delivery valve is also arranged such that the compressed fluid exiting the delivery manifold is controllable.

Another non-limiting aspect of the present invention relates to a gas turbine system. The gas turbine system comprises a compressor arranged to compress fluid, a combustor arranged to combust a mixture of fuel and the compressed fluid provided from the compressor via a compressed fluid path, a turbine arranged to convert energy of combustion of the mixture from the combustor into useful work, an overboard extractor arranged to perform overboard extraction of the compressed fluid flowing through the compressed fluid path, and a controller arranged to control the overboard extractor. The compressed fluid path is a fluid path arranged to provide the compressed fluid from an exit of the compressor to a combustor head end. The overboard extractor of the gas turbine system comprises a delivery manifold, a delivery valve, a plurality extraction manifolds arranged such that first ends thereof are fluidly connected to the compressed fluid path and second ends thereof are fluidly connected to the delivery manifold, and a plurality of extraction valves corresponding to the plurality of extraction manifolds. The plurality of extraction valves are arranged such that the compressed fluid flowing between the compressed fluid path and the delivery manifold through each extraction manifold is individually controllable by the controller. The delivery valve is arranged to be located downstream of all of the plurality of extraction manifolds along the delivery manifold. The delivery valve is also arranged such that the compressed fluid exiting the delivery manifold is controllable by the controller.

Yet another non-limiting aspect of the present invention relates to a method performed operating the overboard extractor described above. The method comprises setting the plurality of extraction valves and the delivery valve such that each extraction manifold is either open or closed. Through each open extraction manifold, a flow of the compressed fluid is either an extraction flow or an injection flow. The extraction flow is the flow of the compressed fluid in a direction from the compressed fluid path to the delivery manifold and the injection flow is the flow of the compressed fluid in an opposite direction.

The invention will now be described in greater detail in connection with the drawings identified below.

### BRIEF DESCRIPTION OF THE DRAWINGS

These and other features of the present invention will be better understood through the following detailed description of example embodiments in conjunction with the accompanying drawings, in which:

FIG. 1 illustrates a gas turbine system according to an embodiment of the present invention;

FIG. 2 illustrates an overboard extractor showing example locations of extraction manifolds according to an embodiment of the present invention;

FIG. 3 illustrates an example configuration of an overboard extractor according to an embodiment of the present invention;

FIG. 4 illustrates another example configuration of an overboard extractor according to an embodiment of the present invention;

FIG. 5 illustrates an example of an overboard extractor operating in an extraction mode according to an embodiment of the present invention;

FIG. 6 illustrates another example of an overboard extractor operating in the extraction mode according to an embodiment of the present invention;

FIG. 7 illustrates an example of an overboard extractor operating in a closed loop mode according to an embodiment of the present invention;

FIG. 8 illustrates an example of an overboard extractor operating in a mixed mode according to an embodiment of the present invention;

FIG. 9 illustrates a flow chart of an example method for overboard extraction; and

FIG. 10 illustrates an example bidirectional valve according to an embodiment of the present invention.

### DETAILED DESCRIPTION OF THE INVENTION

One or more aspects of a novel multiple point overboard extractor, a gas turbine system incorporating the multiple point overboard extractor and a method for overboard extraction are described. Among many advantages, the inventive aspects enable operability, emissions, and durability benefits in using the gas turbine system.

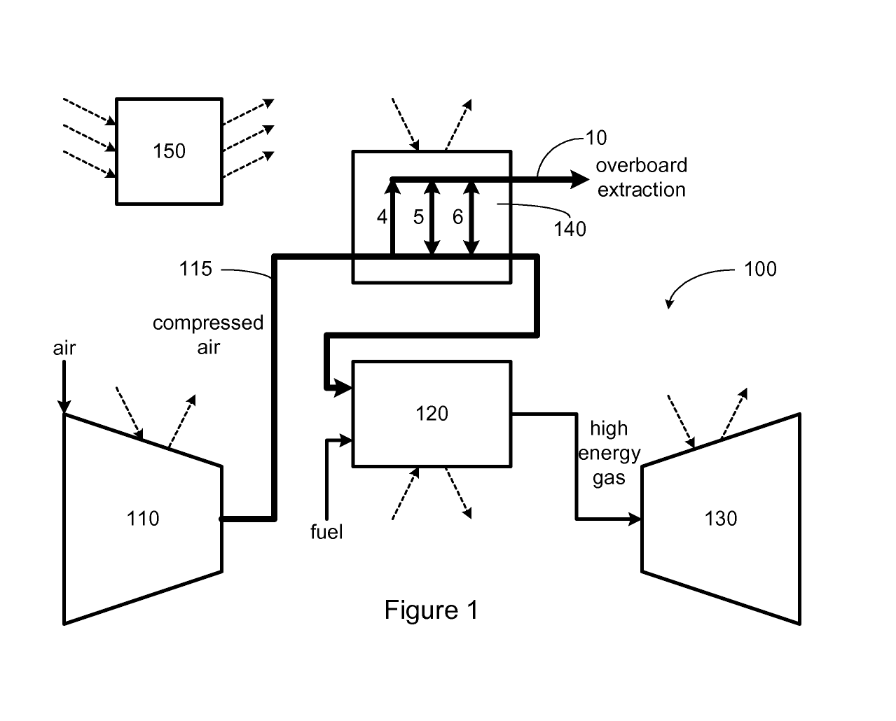

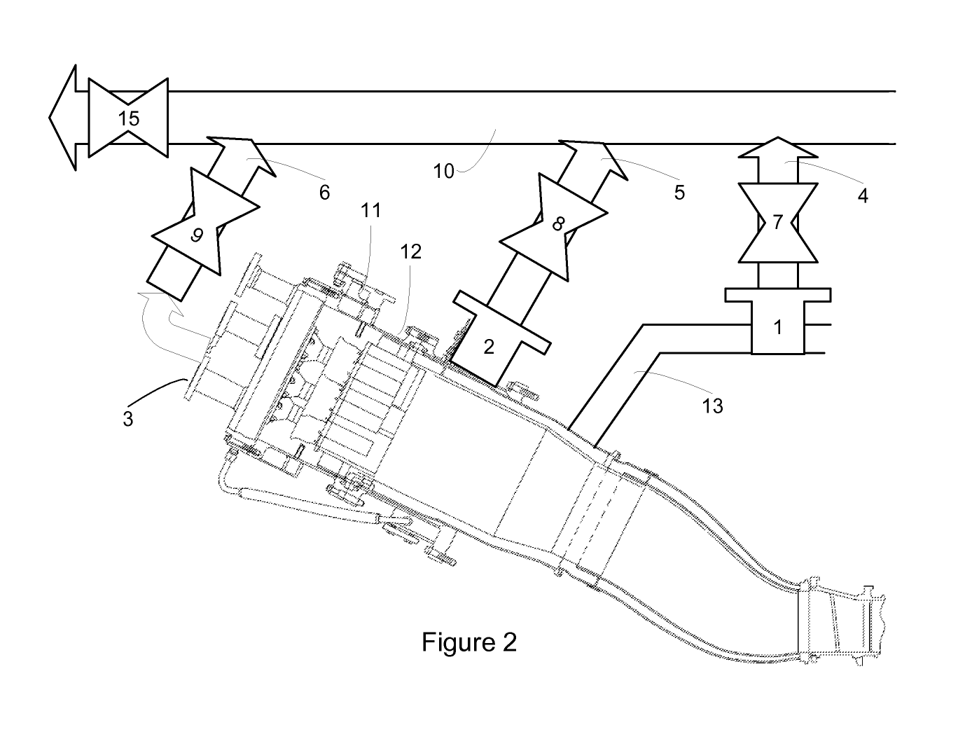

FIG. 1 illustrates a gas turbine system 100 according to an embodiment of the present invention. The example gas turbine system 100 includes a compressor 110, a combustor 120, a turbine or an expander 130, an overboard extractor 140, and a controller 150. The compressor 100 is arranged to compress fluid such as air. The compressed fluid is provided to the combustor 120 via a compressed fluid path 115. In this embodiment, the compressed fluid path 115 is fluid path from an exit of the compressor 110 to a head end 11 (see FIG. 2) of the combustor 120.

Note that in an example gas turbine system 100, the compressed fluid flows in a “flow sleeve” that surround the interior of the turbine where combustion takes place to cool the combustor hardware during operation. Thus, in on aspect, it can be said that the compressed fluid path 115 comprises the flow sleeve.

The combustor 120 is arranged to combust a mixture of fuel and the compressed fluid and provides high energy gas to the turbine 130. The turbine 130 is arranged to convert the energy of combustion of the mixture (i.e., the high energy gas) into useful work. The overboard extractor 140 is arranged to perform overboard extraction of the compressed fluid.

The controller 150 is arranged to control the operation of the gas turbine system 100 by controlling one or more of the compressor 110, the combustor 120, the turbine 130 and the overboard extractor 140. In FIG. 1, the dashed lines entering the controller 150 represent inputs from any one or more of the components 110, 120, 130 and 140 (e.g., sensor information) of the gas turbine system 100 as well as human operator commands. The dashed lines exiting the controller 150 represent outputs provided to any one or more the components 110, 120, 130, 140 (e.g., control signals) as well as informational outputs to the human operator. The dashed lines entering the components 110, 120, 130, 140 represent inputs such as control signals from the controller 150 and the dashed lines exiting the same components represent outputs such as sensor information.

Note that the gas turbine system 100 illustrated in FIG. 1 is a logical illustration, i.e., this is not necessarily a physical representation. For example, FIG. 1 illustrates that the overboard extractor 140 includes extraction manifolds 4, 5, 6. This should not be taken to indicate that the structures that make up the extraction manifolds 4, 5, 6 are physically enclosed or somehow physically compartmentalized.

FIG. 2 illustrates the overboard extractor 140 showing example locations of the extraction manifold 4, 5, 6 according to an embodiment of the present invention. FIG. 2 more closely corresponds to the physical structures as compared to FIG. 1. Nonetheless, FIG. 2 should also be taken as a logical illustration at least to some extent. As seen in FIG. 2, the overboard extractor 140 includes a plurality of extraction manifolds 4, 5, 6 located along the compressed fluid path 115. While three extraction manifolds are shown, there can be any number of extraction manifolds along the compressed fluid path 115. Preferably, there are multiple extraction manifolds.

The example extraction manifolds 4, 5, 6 of FIG. 2 respectively include extraction ports 1, 2, 3 that are located respectively in a vicinity of the compressor discharge (CDC) or wrapper 13, in a vicinity of the combustor casing 12, and in a vicinity of the head end 11 of the combustor 120. For the remainder of this disclosure, the extraction manifolds 4, 5 and 6 will also be referred to as the CDC, combustor casing and combustor head end extraction manifolds. Again, it is emphasized that these are just examples. There can be any number of extraction manifolds located along the compressed fluid path 115.

The extraction manifolds 4, 5, 6 are ultimately connected to the delivery manifold 10. The overboard extractor 140 also includes extraction valves 7, 8, 9 corresponding to the extraction manifolds 4, 5, 6. By setting the extraction valves 7, 8, 9, the flow of the compressed fluid through the extraction manifolds 4, 5, 6 can be controlled. The overboard extractor 140 further includes a delivery valve 15 located along the delivery manifold 10 downstream of all extraction manifolds 4, 5, 6. By setting the delivery valve 15, aspects of the compressed fluid exiting the delivery manifold 10 can be controlled. Thus, in an embodiment, any one ore more of the extraction and delivery valves 7, 8, 9 and 15 are individually controllable. Most preferably, all valves are individually controllable.

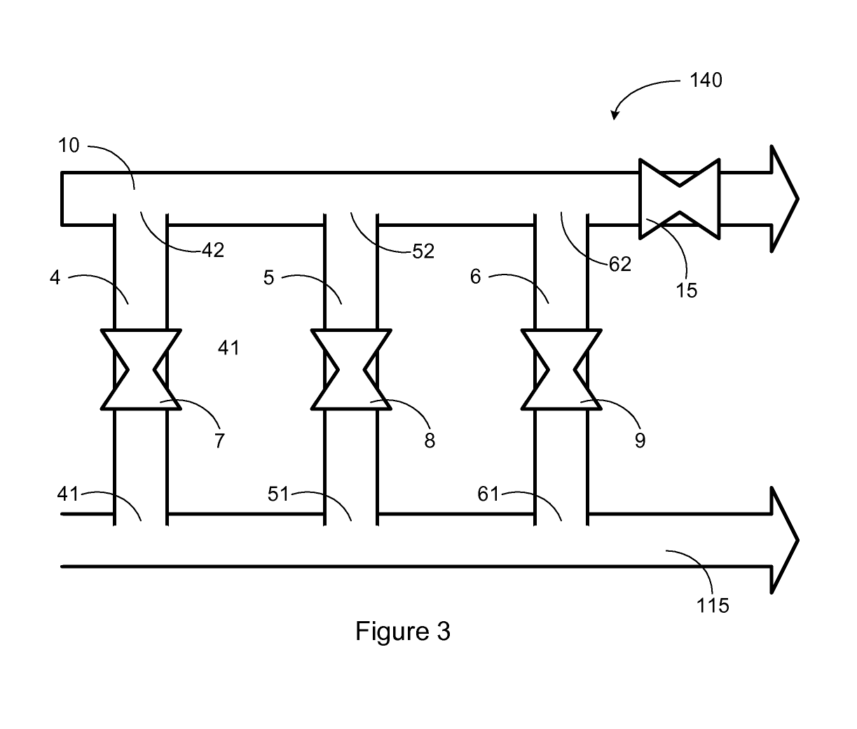

FIG. 3 illustrates an example configuration of the overboard extractor 140 according to an embodiment of the present invention. As seen, the overboard extractor 140 comprises plurality extraction manifolds 4, 5, 6; a plurality of extraction valves 7, 8, 9; a delivery manifold 10 and a delivery valve 15. The first ends 41, 51, 61 (corresponding to the extraction ports 1, 2, 3) of the extraction manifolds 4, 5, 6 are fluidly connected to a compressed fluid path 115, and the seconds ends 42, 52, 62 are fluidly connected to the delivery manifold 10. The extraction valves 7, 8, 9 are arranged such that the compressed fluid flowing through the corresponding extraction manifolds 4, 5, 6 are individually controllable. It is seen that whenever any of the extraction valves 7, 8, 9 is open, the delivery manifold 10 is in fluid communication with the compressed fluid path 115 through the corresponding extraction manifold 4, 5, 6. FIG. 3 can be said to illustrate a configuration in which at least one extraction valve 7, 8, 9 is located an extraction manifold 4, 5, 6.

The delivery valve 15 in this embodiment is located downstream of all extraction manifolds 4, 5, 6 along the delivery manifold 10, and is arranged such that the compressed fluid exiting the delivery manifold 10 is controllable. While not specifically indicated in FIG. 3, it is assumed that at least one, and preferably all, of the extraction valves 4, 5, 6 and the delivery valve 15 can be individually set by the controller 150.

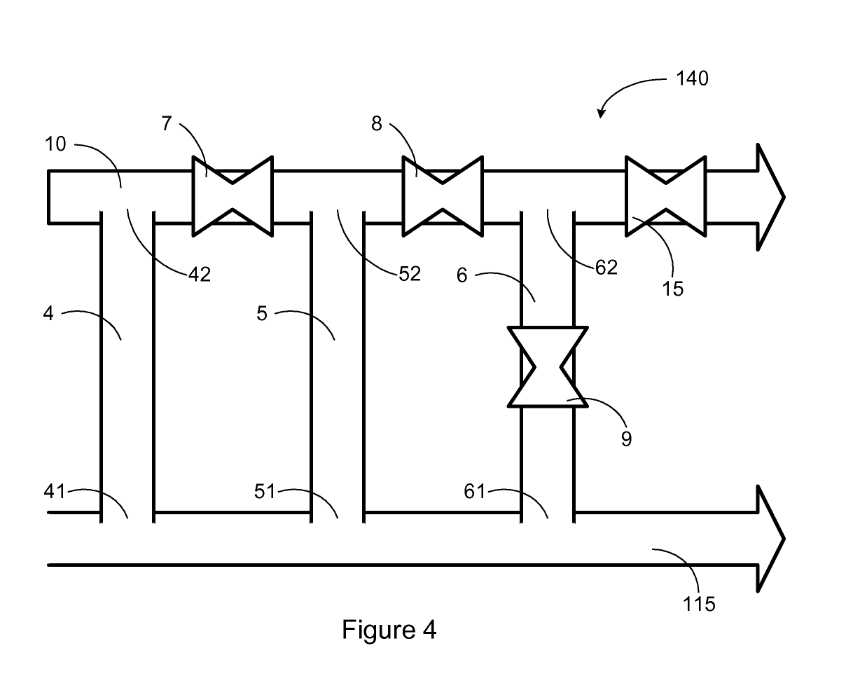

FIG. 4 illustrates another example configuration of the overboard extractor 140 according to an embodiment of the present invention. FIG. 4 differs from FIG. 3 in that the extraction valves 7 and 8 corresponding to the extraction manifolds 4 and 5 are located within the delivery manifold 10. Thus, FIG. 4 can be said to illustrate a configuration in which at least one extraction valve 7, 8 is located the delivery manifold 10. Note that flows of the compressed fluid flowing through the extraction manifolds 4, 5, 6 in FIG. 4 are just as controllable relative to FIG. 3. For each of the extraction valve 7 and 8 in the delivery manifold 10, its location is in between two extraction manifolds—upstream of one and downstream of another. For example, the extraction valve 8 is upstream of the extraction manifold 6 and downstream of the extraction manifold 5.

It should be understood that configuration is not limited to FIGS. 3 and 4. The configuration of the extracting system 140 may be a combination of FIGS. 3 and 4. i.e., some extraction valves may be located in the extraction manifold while other may be located in the delivery manifold. For the remainder of this disclosure, the configuration illustrated in FIG. 3 will be used for explanation. However, it should be understood that the information presented will be readily applicable to the configuration illustrated in FIG. 4 as well as to non-illustrated configurations.

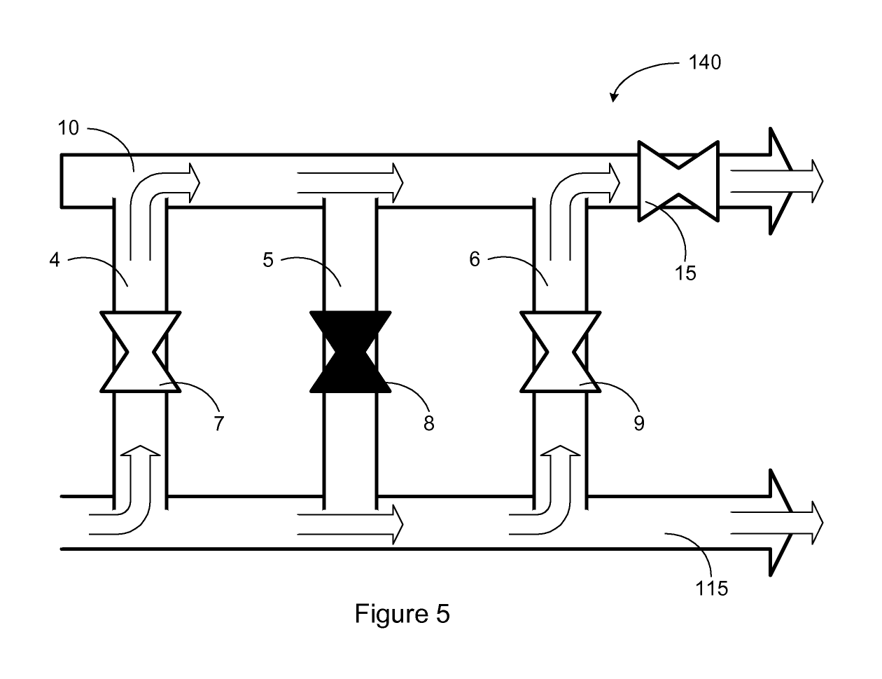

FIG. 5 illustrates the overboard extractor 140 operating in a delivery mode, also referred to as an extraction mode, according to an embodiment of the present invention. In this figure and in the figures to follow, a white valve indicates that the valve is at least partially open, and a black valve indicates that the valve is totally closed. Thus, in FIG. 5, the extraction valve 5 is fully closed, and the delivery valve 15 and the extraction valves 4 and 6 are at least partially open. The controller 150 can set any one or more of these valves individually to be in any state of openness from fully closed to fully open.

Note that whenever a valve is open—either partially or fully—the corresponding extraction manifold provides fluid communication between the compressed fluid path 115 and the delivery manifold 10. For the purposes of discussion, any extraction manifold corresponding to the extraction valve that is at least partially open will also be referred to as “open” extraction manifold. In FIG. 5, the CDC extraction manifold 4 and the combustor head end extraction manifold 6 are open extraction manifolds. Conversely, the combustor casing extraction manifold 5 is a “closed” extraction manifold.

Through any open extraction manifold, the compressed fluid can flow in the direction from the compressed fluid path 115 to the delivery manifold 10 or vice versa. For discussion purposes, the flow in the direction from the compressed fluid path 115 to the delivery manifold will be referred to as an “extraction” flow and the flow in the opposite direction will be referred to as an “injection” flow.

In FIG. 5, it is seen that the flows within the extraction manifolds 4 and 6 are both extraction flows. It is also seen that these extraction flows exit the delivery manifold 10. This is an example of the overboard extractor 140 operating in the delivery mode. Generally, the delivery mode is an operation mode in which there are only extraction flows through the extraction manifolds such that all extraction flows exit the delivery manifold 10. In this mode, the compressed fluid extracted from the extraction manifolds can be used outside the combustor 120 for useful purposes such as to enhance emissions and durability.

The following should be understood. The delivery mode does not require that all extraction manifolds be open. However, the delivery does indicate that at least one extraction manifold is an open extraction manifold. Also for each open extraction manifold, the compressed fluid flow through that extraction manifold is an extraction flow. Relating this to FIG. 5, it is clear that not all extraction manifolds are open (the combustor casing extraction manifold 5 is closed). However, for the open extraction manifolds (CDC and combustor head end extraction manifolds 4 and 6), the flow through these extraction manifolds are extraction flows, and all extraction flows exit the delivery manifold 10 through the delivery valve 15 which is fully open in this instance.

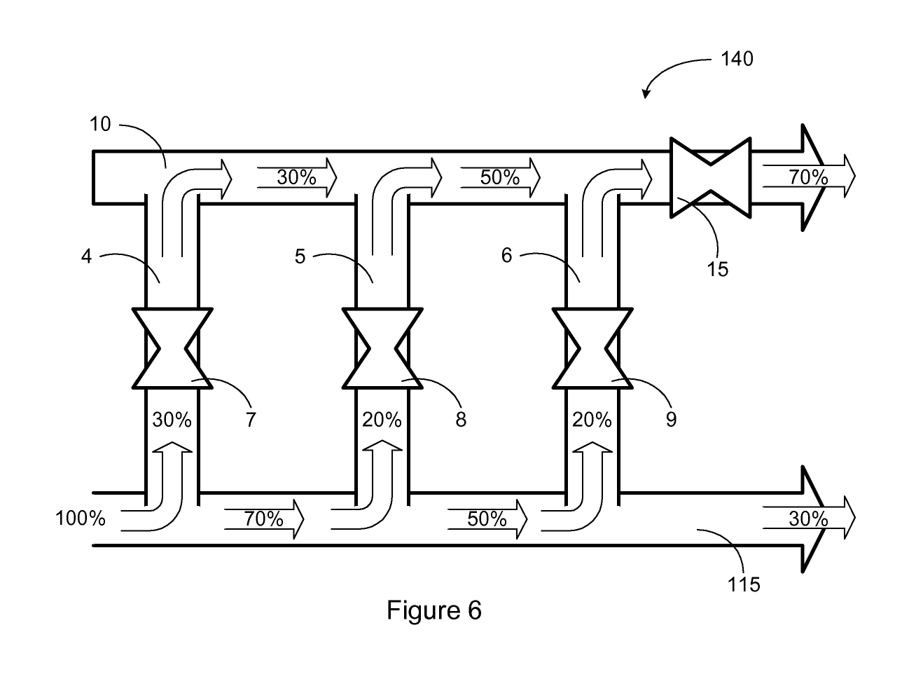

The delivery mode can be useful when a large amount of compressed fluid is desired to be extracted, for example, during a turn down. Being able to set the extraction valves individually allows the compressed fluid to be optimally distributed. This is explained with reference to FIG. 6. As seen, the overboard extractor 140 in this figure is also operating in the delivery mode. It is assumed that the controller 150 has set the extraction valves 7, 8, 9 such that all three extraction manifolds 4, 5, 6 are open extraction manifolds.

Assume that a large quantity such as 70% of the compressed fluid is desired to be extracted. If the entire 70% is pulled from the CDC, this leaves only 30% for combustor cooling, which is very unlikely to be sufficient. In other words, cooling starvation may result. However, in the example of FIG. 6, the extraction valves 7, 8, 9 and possibly the delivery valve 15 are set such that the 70% pulling of the compressed fluid is distributed—30% through the CDC extraction manifold 4, 20% through the combustor casing extraction manifold 5 and 20% also from the combustor head end extraction manifold 6. When 30% is pulled from the vicinity of the CDC 13, this leaves 70% to cool the transition pieces and liners of the combustor 120, which should be sufficient. Pulling 20% from the vicinity of the combustor casing 12 leaves 50% to cool the head end 11. Finally, the remaining 20% is pulled near the vicinity of the head end 11. Thus, the desired 70% is extracted and the combustor parts are sufficiently cooled in the process. This can prevent cooling starvation while still allowing the extracted compressed fluid to be used outside the combustor 120 for other useful purposes.

The delivery mode is but one of several operating modes of the overboard extractor 140. Other operating modes include the closed loop and mixed modes. As seen in FIGS. 5 and 6, there are only extraction flows when the overboard extractor 140 operates in the delivery mode. But when the overboard extractor 140 operates in either the closed loop mode or the mixed mode, there are both extraction and injection flows.

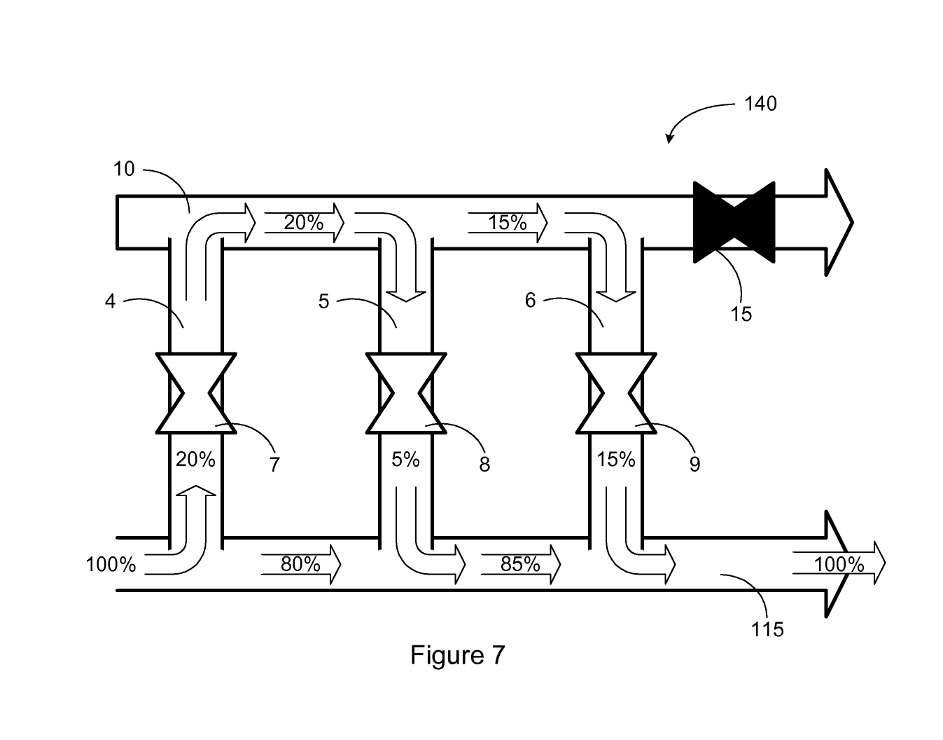

FIG. 7 illustrates an example of the overboard extractor 140 operating in the closed loop mode. As seen, all three extraction manifolds 4, 5, 6 are open extraction manifolds. Again, it should be emphasized that not all extraction manifolds need be open extraction manifolds in the closed loop mode. Indeed, there is no such requirement in any of the delivery, closed loop and mixed operating modes. In the closed loop mode however, there is at least one extraction flow and at least one injection flow.

One characteristic of the closed loop is that the delivery valve is completely closed, which is indicated in FIG. 7 by the blackened delivery valve 15. As such, no compressed fluid exits the delivery manifold 10. In other words, the closed loop mode is characterized in that the compressed fluid is not extracted for use outside the combustor 120. Thus, in the closed loop mode, the sum of all extraction flows is equal to the sum of all injection flows, and substantially all of the compressed fluid from the compressor 110 is provided to the head end 11 of the combustor 120 for combustion. In FIG. 7, the extraction flow through the CDC extraction manifold 4 is equal to the sum of injection flows through the combustor casing and head end extraction manifolds 5 and 6.

The closed loop mode can be used to provide preferential cooling and/or supply extra fluid for premixing to thereby control emissions. As an illustration, in FIG. 7, 20% of the compressed fluid is assumed to be diverted from the compressed fluid path 115 to the delivery manifold 10, 5% of the diverted compressed fluid is injected back to the compressed fluid path 115 through the combustor casing extraction manifold 5 and the remaining 15% is injected back through the combustor head end extraction manifold 6. In so doing, extra flow is injected into the cold side of the flow sleeve/liner to thereby control cooling. Also extra flow is injected to the head end 11 to provide preferential cooling of the head end 11 and/or supply extra fluid for premixing to thereby control emissions.

Such diversion from the compressed fluid path 115 to the delivery manifold 10 and back requires control over the direction of the compressed fluid flows through the extraction manifolds, i.e., requires control to set the flows to be extraction or injection flows. In one embodiment, such directionality is be achieved is through taking advantage of the fact that the pressure of the compressed fluid is higher at upstream locations than at downstream locations. For example, the pressure at the CDC 13 will be higher than either at the combustion casing 12 or at the combustor head end 11. Thus, by properly setting the amount of openness of the extraction valves 7, 8, 9, the flow directions through each open extraction manifold can be controlled.

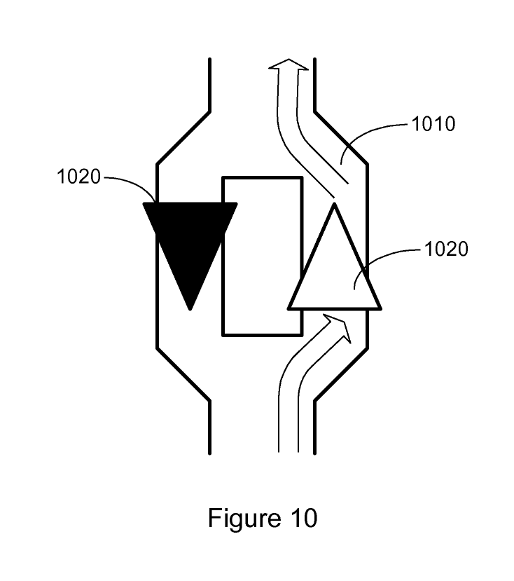

But in another embodiment, bidirectional valves can be utilized to enhance the direction control. As illustrated in FIG. 10, two unidirectional valves 920 can be utilized to achieve bidirectional control in a manifold 910. In this particular example, the flow is upward. By individually controlling an amount of openness of each unidirectional valve 1020, the flow direction as well as the net flow can be controlled.

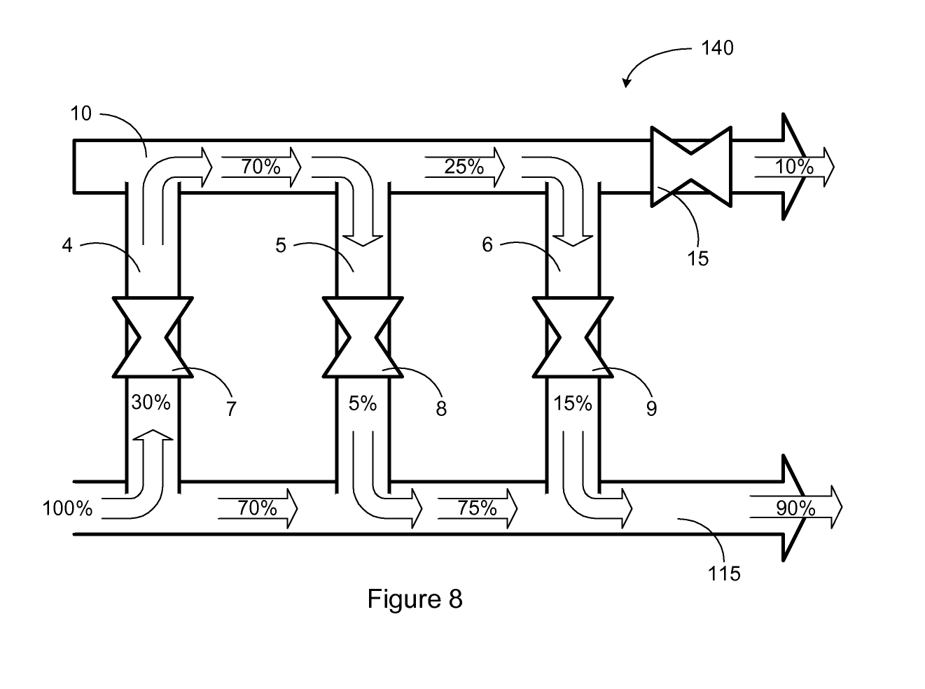

FIG. 8 illustrates an example of the overboard extractor 140 operating in the mixed mode according to an embodiment of the present invention. As the name implies, the mixed mode is a combination of the delivery and closed loop modes. Like the closed loop mode, there is at least one extraction flow and at least one injection flow in the mixed mode. But unlike the closed loop mode (and like the delivery mode), the delivery valve 15 is at least partially open. In FIG. 8, the extraction valves 7, 8, 9 and the delivery valve 15 are set so that some of the compressed fluid is extracted and some are preferentially redirected.

In one type of mixed mode operation, the compressed fluid can be extracted from one port (e.g., the CDC) to be used external to the combustor 120 for flame temperature control, for emissions control, for durability enhancement, and so on. Other ports (e.g., the combustor casing, head end) can be sued for injection to enhance cooling and/or emissions control.

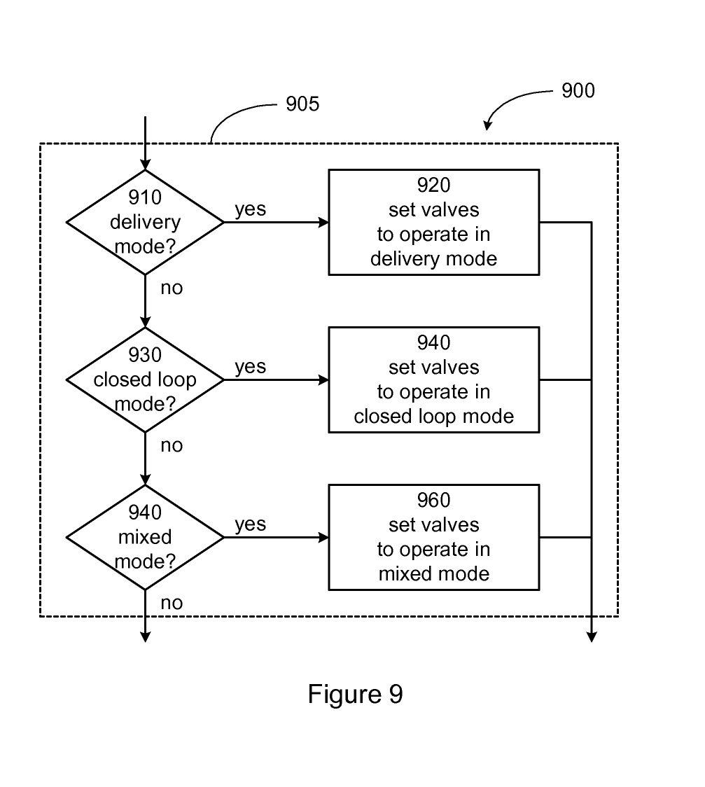

FIG. 9 illustrates a flow chart of an example method 900 for overboard extraction. In an aspect, the controller 150 performs the method to control any one or more of the components of the gas turbine system 100. In particular, the controller 150 in step 905 sets any one or more of the extraction and delivery valves 7, 8, 9, 15 of the overboard extractor 140 such that each extraction manifold 4, 5, 6 is either open or closed and such that the compressed fluid through each open extraction manifold is either the extraction flow or the injection flow.

More specifically, in step 910, the controller 150 determines whether the overboard extractor 140 should be operating in the delivery mode. If so, the controller 150 sets the valves 7, 8, 9, 15 so that the overboard extractor 140 operates in the delivery mode. Otherwise, in step 930, the controller 150 determines whether the overboard extractor 140 should be operating in the closed loop mode. If so, the controller 150 sets the valves 7, 8, 9, 15 accordingly in step 940. Otherwise, in step 950, the controller 150 determines whether the overboard extractor 140 should be operating in the mixed mode. If so, the controller 150 sets the valves 7, 8, 9, 15 accordingly in step 960.

The inventive aspects provide durability, operation, emission and cost benefits. A non-exhaustive list of advantages include:
Capability to handle high extraction flows;
Control over combustor pressure loss;
Preferential cooling for emissions and flame control;
Combustor fluid management;
Control over base load emissions and turndown; and
Flexibility over combustion thermal state management.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. An overboard extractor for overboard extraction of compressed fluid from a compressor of a gas turbine system, the overboard extractor comprising:
a delivery manifold;
a delivery valve;
a plurality extraction manifolds arranged such that first ends thereof are fluidly connected to a compressed fluid path and second ends thereof are fluidly connected to the delivery manifold; and
a plurality of extraction valves corresponding to the plurality of extraction manifolds,
wherein the compressed fluid path is a fluid path arranged to provide the compressed fluid from an exit of the compressor to a combustor head end,
wherein the plurality of extraction valves are arranged such that the compressed fluid flowing between the compressed fluid path and the delivery manifold through each extraction manifold is individually controllable; and
wherein the delivery valve is arranged to be located downstream of all of the plurality of extraction manifolds along the delivery manifold, and arranged such that the compressed fluid exiting the delivery manifold is controllable.

2. The overboard extractor of claim 1, wherein at least one extraction valve is located in the corresponding extraction manifold.

3. The overboard extractor of claim 1, wherein at least one extraction valve is located in the delivery manifold upstream of one extraction manifold and downstream of another extraction manifold.

4. The overboard extractor of claim 1,
wherein the plurality of extraction valves and the delivery valve are controllable such that each extraction manifold is either open or closed, each open extraction manifold providing fluid communication between the compressed fluid path and the delivery manifold,
wherein through each open extraction manifold, a flow of the compressed fluid is either an extraction flow or an injection flow, and
wherein the extraction flow is the flow of the compressed fluid in a direction from the compressed fluid path to the delivery manifold and the injection flow is the flow of the compressed fluid in an opposite direction.

5. The overboard extractor of claim 4,
wherein the plurality of extraction valves and the delivery valve are controllable such that the overboard extractor operates in a delivery mode, and
wherein the delivery mode is an operation mode in which there are only extraction flows such that all extraction flows exit the delivery manifold.

6. The overboard extractor of claim 4,
wherein the plurality of extraction valves and the delivery valve are controllable such that the overboard extractor operates in a closed loop mode, and
wherein the closed loop mode is an operation mode in which there is at least one extraction flow and at least one injection flow, and a sum of all extraction flows is equal a sum of all injections flows such that no extraction flow exits the delivery manifold.

7. The overboard extractor of claim 4,
wherein the plurality of extraction valves and the delivery valve are controllable such that the overboard extractor operates in a mixed mode, and
wherein the mixed mode is an operation mode in which there is at least one extraction flow and at least one injection flow and a sum of all extraction flows is greater than a sum of all injections flows such that a portion of the extraction flow sum exits the delivery manifold.

8. The overboard extractor of claim 1, wherein the plurality of extraction manifolds comprise:
a compressor discharge (CDC) extraction manifold fluidly connected to the compressed fluid path in a vicinity of a wrapper;
a combustor casing extraction manifold fluidly connected to the compressed fluid path downstream of the CDC extraction manifold and in a vicinity of a combustor casing; and
a combustor head end extraction manifold fluidly connected to the compressed fluid path downstream of the combustor casing extraction manifold and in a vicinity of the combustor head end.

9. A gas turbine system comprising:
a compressor arranged to compress fluid;
a combustor arranged to combust a mixture of fuel and the compressed fluid provided from the compressor via a compressed fluid path;
a turbine arranged to convert energy of combustion of the mixture from the combustor into useful work;
an overboard extractor arranged to perform overboard extraction of the compressed fluid flowing through the compressed fluid path; and
a controller arranged to control the overboard extractor,
wherein the compressed fluid path is a fluid path arranged to provide the compressed fluid from an exit of the compressor to a combustor head end,
wherein the overboard extractor comprises:
a delivery manifold;
a delivery valve;
a plurality extraction manifolds arranged such that first ends thereof are fluidly connected to the compressed fluid path and second ends thereof are fluidly connected to the delivery manifold; and
a plurality of extraction valves corresponding to the plurality of extraction manifolds,
wherein the plurality of extraction valves are arranged such that the compressed fluid flowing between the compressed fluid path and the delivery manifold through each extraction manifold is individually controllable by the controller; and
wherein the delivery valve is arranged to be located downstream of all of the plurality of extraction manifolds along the delivery manifold, and arranged such that the compressed fluid exiting the delivery manifold is controllable by the controller.

10. The gas turbine system of claim 9, wherein at least one extraction valve is located in an extraction manifold.

11. The gas turbine system of claim 9, wherein at least one extraction valve is located in the delivery manifold upstream of one extraction manifold and downstream of another extraction manifold.

12. The gas turbine system of claim 9,
wherein the plurality of extraction valves and the delivery valve are controllable such that each extraction manifold is either open or closed, each open extraction manifold providing fluid communication between the compressed fluid path and the delivery manifold,
wherein through each open extraction manifold, a flow of the compressed fluid is either an extraction flow or an injection flow, and
wherein the extraction flow is the flow of the compressed fluid in a direction from the compressed fluid path to the delivery manifold and the injection flow is the flow of the compressed fluid in an opposite direction.

13. The gas turbine system of claim 12,
wherein the controller is arranged to control the plurality of extraction valves and the delivery valve such that the overboard extractor operates in a delivery mode, and
wherein the delivery mode is an operation mode in which there are only extraction flows such that all extraction flow exits the delivery manifold.

14. The gas turbine system of claim 12,
wherein the controller is arranged to control the plurality of extraction valves and the delivery valve such that the overboard extractor operates in a closed loop mode, and
wherein the closed loop mode is an operation mode in which there is at least one extraction flow and at least one injection flow, and a sum of all extraction flows is equal a sum of all injections flows such that no extraction flow exits the delivery manifold.

15. The gas turbine system of claim 12,
wherein the controller is arranged to control the plurality of extraction valves and the delivery valve such that that the overboard extractor operates in a mixed mode, and
wherein the mixed mode is an operation mode in which there is at least one extraction flow and at least one injection flow and a sum of all extraction flows is greater than a sum of all injections flows such that a portion of the extraction flow sum exits the delivery manifold.

16. The gas turbine system of claim 9, wherein the plurality of extraction manifolds comprise:
a compressor discharge (CDC) extraction manifold fluidly connected to the compressed fluid path in a vicinity of a wrapper;
a combustor casing extraction manifold fluidly connected to the compressed fluid path downstream of the CDC extraction manifold and in a vicinity of a combustor casing; and
a combustor head end extraction manifold fluidly connected to the compressed fluid path downstream of the combustor casing extraction manifold and in a vicinity of the combustor head end.

17. A method performed for operating an overboard extractor of claim 1, the method comprising:
setting the plurality of extraction valves and the delivery valve such that each extraction manifold is either open or closed,
wherein through each open extraction manifold, a flow of the compressed fluid is either an extraction flow or an injection flow, and
wherein the extraction flow is the flow of the compressed fluid in a direction from the compressed fluid path to the delivery manifold and the injection flow is the flow of the compressed fluid in an opposite direction.

18. The method of claim 17,
wherein the step of setting the plurality of extraction valves and the delivery valve comprises setting the plurality of extraction valves and the delivery valve such that the overboard extractor operates in a delivery mode, and
wherein the delivery mode is an operation mode in which there are only extraction flows such that all extraction flow exits the delivery manifold.

19. The method of claim 17,
wherein the step of controlling the plurality of extraction valves and the delivery valve comprises setting the plurality of extraction valves and the delivery valve such that the overboard extractor operates in a closed loop mode, and
wherein the closed loop mode is an operation mode in which there is at least one extraction flow and at least one injection flow, and a sum of all extraction flows is equal a sum of all injections flows such that no extraction flow exits the delivery manifold.

20. The method of claim 17,
wherein the step of controlling the plurality of extraction valves and the delivery valve comprises setting the plurality of extraction valves and the delivery valve such that the overboard extractor operates in a mixed mode, and
wherein the mixed mode is an operation mode in which there is at least one extraction flow and at least one injection flow and a sum of all extraction flows is greater than a sum of all injections flows such that a portion of the extraction flow sum exits the delivery manifold.
